(19) United States
(12) Patent Application Publication
(10) Pub. No.: US 2015/0158372 A1
(43) Pub. Date: Jun. 11, 2015

(54) TORQUE STRUT

(71) Applicants: Eric F. DeHesselle, Clarkston, MI (US); Hamid Mir, Rochester Hills, MI (US); Daniel R. Ryberg, Lake Orion, MI (US)

(72) Inventors: Eric F. DeHesselle, Clarkston, MI (US); Hamid Mir, Rochester Hills, MI (US); Daniel R. Ryberg, Lake Orion, MI (US)

(21) Appl. No.: 14/103,311

(22) Filed: Dec. 11, 2013

(51) Int. Cl. B60K 1/00

(52) U.S. Cl. CPC B60K 1/00

(57) ABSTRACT

A system for a vehicle may include a vehicle chassis, an electric motor, and a torque strut. The electric motor may include a rotor and may be operable in a first mode to rotate the rotor in a first direction to propel the vehicle about a rotational axis and in a second mode in which the rotor is rotated in a second direction about the rotational axis. The torque strut may include first, second and third mounting structures. The first mounting structure may be coupled to the vehicle chassis. The second and third mounting structures may be spaced apart from each other and may be coupled to the electric motor to prevent relative rotation between the torque strut and the electric motor.

### FIELD

The present disclosure relates to a torque strut for coupling an electric motor to a vehicle chassis.

### BACKGROUND

A vehicle powertrain component such as an engine or motor may tend to roll as a result of a moment caused by torque output of the engine or motor. A torque strut may be used to couple the engine or motor to a vehicle chassis or structural component of the vehicle and react the moment to improve the driver's comfort and feel of the vehicle during vehicle operation.

### SUMMARY

In one form, the present disclosure provides a vehicle system that may include a vehicle chassis, an electric motor, a motor bracket, and a torque strut. The electric motor may include a rotor and may be operable in a first mode to rotate the rotor in a first direction about a rotational axis and in a second mode in which the rotor is rotated in a second direction about the rotational axis. The motor bracket may be attached to the electric motor and may include first and second attachment interfaces. The torque strut may include a body and first, second and third bushings. The first, second and third bushings may each include a mounting aperture having a longitudinal axis that is parallel to the rotational axis of the rotor. The first bushing may be disposed at a first end portion of the body and may be attached to the vehicle chassis. The second bushing may be disposed at a second end portion of the body and may be attached to the first attachment interface of the motor bracket. The third bushing may be disposed between the first and second bushings and may be attached to the second attachment interface of the motor bracket.

In some embodiments, the body may be a monolithic body.

In some embodiments, the torque strut may be attached to the vehicle chassis only at the first bushing.

In some embodiments, a center-of-mass of the torque strut may be disposed between the first and third bushings.

In some embodiments, the first bushing may include a larger diameter than the second and third bushings.

In some embodiments, rotation of the rotor in the second direction may produce electrical energy.

In some embodiments, the body of the torque strut may be formed from a metallic material and the first, second and third bushings are formed from a polymeric material. In some embodiments, the first, second and third bushings may be formed from a metallic material.

In some embodiments, the first bushing may include a plurality of openings arranged around the mounting aperture of the first bushing.

In some embodiments, the torque strut may be tuned to reduce noise generated by the electric motor.

In some embodiments, the second and third bushings may be configured to react a first moment generated by the electric motor when the electric motor is operating in the first mode and a second moment generated by the electric motor when the electric motor is operating in the second mode. The first and second moments may be in opposite directions.

In another form, the present disclosure provides a system for a vehicle that may include a vehicle chassis, an electric motor, and a torque strut. The electric motor may include a rotor and may be operable in a first mode to rotate the rotor in a first direction to propel the vehicle about a rotational axis and in a second mode in which the rotor is rotated in a second direction about the rotational axis. The torque strut may include first, second and third mounting structures. The first mounting structure may be coupled to the vehicle chassis. The second and third mounting structures may be spaced apart from each other and may be coupled to the electric motor to prevent relative rotation between the torque strut and the electric motor.

In some embodiments, the second and third mounting structures may be configured to react a first moment generated by the electric motor when the electric motor is operating in the first mode and a second moment generated by the electric motor when the electric motor is operating in the second mode. The first and second moments may be in opposite directions.

In some embodiments, the torque strut may be attached to the vehicle chassis only at the first mounting structure.

In some embodiments, the electric motor may be mounted to a motor bracket. The torque strut may be attached to the motor bracket only at the second and third mounting structures.

In some embodiments, the torque strut may be tuned to reduce noise generated by the electric motor.

In some embodiments, the first, second and third mounting structures may include first, second and third bushings, respectively.

In some embodiments, the first bushing may include a larger diameter than the second and third bushings.

In some embodiments, a body of the torque strut may be formed from a metallic material and the first, second and third bushings are formed from a polymeric material. In some embodiments, the first, second and third bushings may be formed from a metallic material.

In some embodiments, the first bushing may include a mounting aperture and a plurality of openings arranged around the mounting aperture.

In some embodiments, a center-of-mass of the torque strut may be disposed between the first and third mounting structures.

In some embodiments, each of the first, second and third mounting structures may include a mounting aperture having a longitudinal axis that is parallel to the rotational axis of the rotor.

In some embodiments, rotation of the rotor in the second direction may produce electrical energy.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a system including a torque strut coupling an electric motor to a vehicle chassis according to the principles of the present disclosure;

FIG. 2 is a side view of the torque strut and a motor bracket according to the principles of the present disclosure;

FIG. 3 is a bottom view of the torque strut and motor bracket of FIG. 2;

FIG. 4 is a side view of the torque strut;

FIG. 5 is a schematic representation of the system of FIG. 1; and

FIG. 6 is a graph illustrating noise improvements realized through use of the torque strut of the present disclosure relative to a prior-art torque strut.

### DETAILED DESCRIPTION

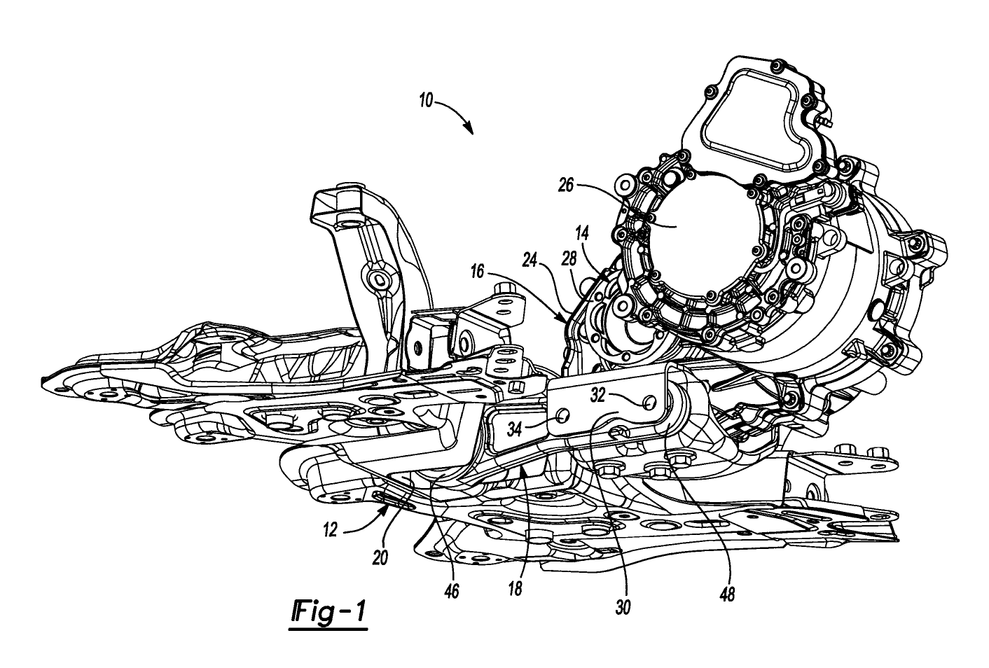

In an exemplary embodiment and with reference to FIGS. 1-6, a vehicle system 10 is provided that may include a vehicle chassis 12, an electric motor 14, a motor bracket 16, and a torque strut 18. As will be described in more detail below, the torque strut 18 couples the motor 14 to the chassis 12 in a manner that restricts or prevents relative rotation between the torque strut 18 and the motor 14 and relative rotation between the torque strut 18 and the chassis 12 while the motor 14 is operating in a propulsion mode and while the motor 14 is operating in a regenerative-braking mode. The torque strut 18 may also be tuned to reduce vibration and noise generated by operation of the motor 14.

The chassis 12 may support a vehicle suspension (not shown), a passenger compartment (not shown) of the vehicle, and a vehicle powertrain (including the motor 14). The chassis 12 may include a recess 20 (FIGS. 1 and 3) that receives a portion of the torque strut 18 for attachment of the torque strut 18 to the chassis 12. Mounting apertures 21 (FIG. 3) may extend through the chassis 12 and into the recess 20.

When the motor 14 is operating in the propulsion mode, a rotor 22 (shown schematically in FIG. 5) of the motor 14 may rotate in a first direction D1 to drive wheels of the vehicle. When the motor 14 is operating in the regenerative-braking mode, the rotor 22 may rotate in a second direction D2 to slow the vehicle and generate electrical energy through a regenerative-braking process. The rotor 22 may drivingly engage gears (not shown) disposed within a gearbox 26.

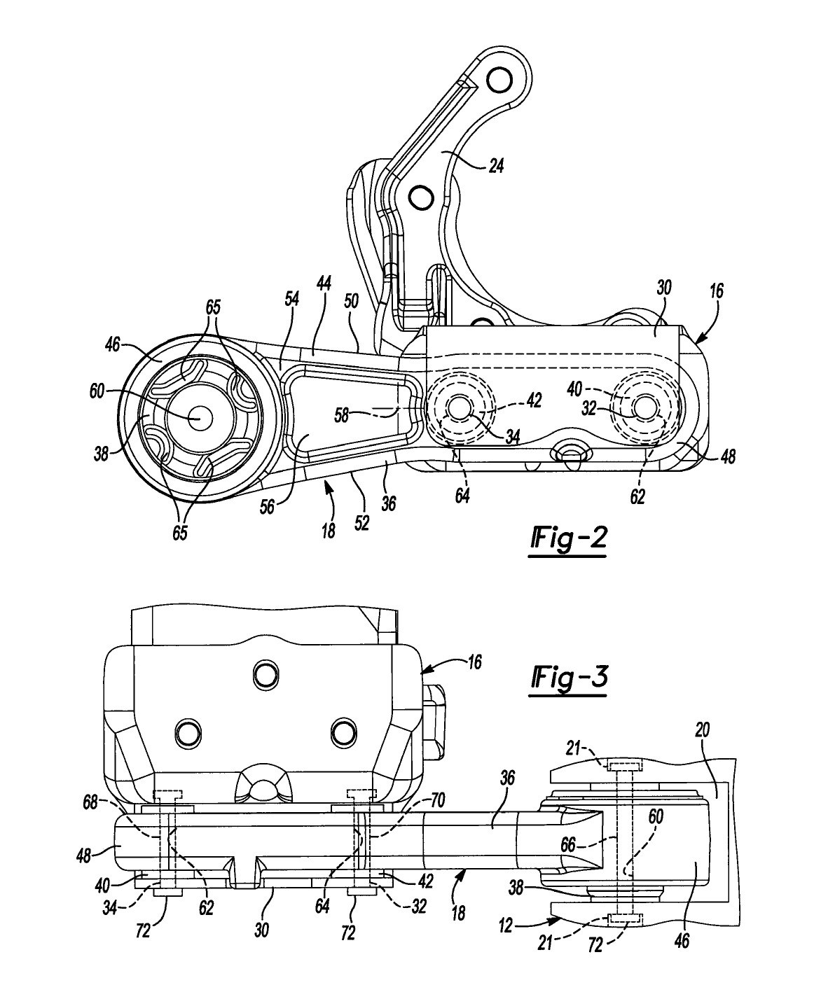

The motor bracket 16 may be attached to the torque strut 18 and may support the motor 14 and the gearbox 26. The motor bracket 16 may include a generally C-shaped arm 24 (FIG. 2) to which a housing 28 of the motor 14 may be fastened. The motor bracket 16 may also include a U-shaped mounting flange 30 including first and second apertures 32, 34 extending therethrough.

The torque strut 18 may include a body 36, a first bushing 38, a second bushing 40 and a third bushing 42. The body 36 may be a monolithic body formed from a metallic material, such as steel, aluminum or any other metallic or composite material. While the body 36 is shown in the figures as including a tapered portion 44 disposed between first and second end portions 46, 48 of the body 36, in some embodiments, edges 50, 52 of the body 36 may be substantially planar and parallel to each other between the first and second end portions 46, 48. As shown in FIGS. 2, 4 and 5, one or both side faces 54 may include a recessed portion 56 disposed between the first and third bushings 38, 42.

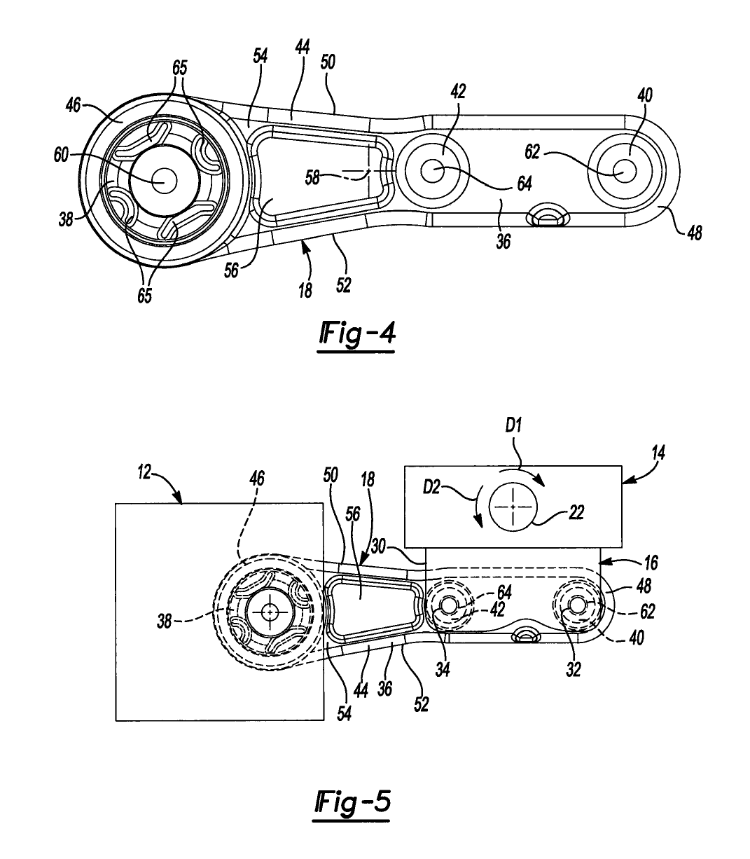

The first bushing 38 may be disposed at the first end portion 46 of the body 36. The second bushing 40 may be disposed at the second end portion 48 of the body 36. The third bushing 42 may be disposed between the first and second bushings 38, 40. The third bushing 42 may be disposed a first distance from the second bushing 40 and a second distance from the first bushing 38. The first distance may be shorter than the second distance. As shown in FIG. 4, a center-of-mass 58 of the torque strut 18 may be disposed between the first and third bushings 38, 42.

In some embodiments, the bushings 38, 40, 42 may be integrally formed with the body 36. In some embodiments, the bushings 38, 40, 42 may be formed separately from the body 36 and attached thereto by a press or interference fit, welding and/or any other suitable attachment method. In some embodiments, the bushings 38, 40, 42 may be formed from the same metallic material or a different metallic material as the body 36. In some embodiments, the bushings 38, 40, 42 may be formed at least partially from a polymeric material.

The first, second and third bushings 38, 40, 42 may include first, second and third mounting apertures 60, 62, 64, respectively, extending therethrough. The mounting apertures 60, 62, 64 may have longitudinal axes that are substantially parallel to a rotational axis of the rotor 22. The first bushing 38 may include a plurality of recesses and/or openings 65 arranged around the first mounting aperture 60. The openings 65 may extend partially or completely through the first bushing 38. In some embodiments, the recesses and/or openings 65 may be provided to achieve a desired mass, mass distribution and/or rigidity of the torque strut 18. It will be appreciated that, in some embodiments, the second and/or third bushings 40, 42 may include recesses and/or openings.

As shown in FIG. 3, a first fastener 66 may extend through the first mounting aperture 60 of the first bushing 38 and may be received in the mounting apertures 21 of the chassis 12 to secure the torque strut 18 to the chassis 12. A second fastener 68 may extend through the second mounting aperture 62 of the second bushing 40 and the apertures 32 of the motor bracket 16. The third fastener 70 may extend through the third mounting aperture 64 of the third bushing 42 and the apertures 34 of the motor bracket 16. The fasteners 66, 68, 70 may be or include pins, rivets or bolts, for example, and/or any other fastening devices. As shown in FIG. 3, nuts 72 may engage the fasteners 66, 68, 70 to retain the fasteners 66, 68, 70 within the bushings 38, 40, 42.

While not shown in the drawings, it will be appreciated that other struts, brackets and/or other support structures may be provided in addition to the torque strut 18 to secure the motor 14 and/or the motor bracket 16 relative to the chassis 12.

As described above, the torque strut 18 couples the motor 14 to the chassis 12 in a manner that restricts or prevents relative rotation between the torque strut 18 and the motor 14 and relative rotation between the torque strut 18 and the chassis 12 while the motor 14 is operating in the propulsion mode and while the motor 14 is operating in the regenerative-braking mode. When the motor 14 is operating in the propulsion mode (i.e., when the rotor 22 is rotating in the first direction D1), a first reaction moment is generated in a direction opposite to the first direction D1 that biases the motor housing 28 in the second direction D2 relative to the torque strut 18 and chassis 12. When the motor 14 is operating in the regenerative-braking mode (i.e., when the rotor 22 is rotating in the second direction D2), a second reaction moment is generated in a direction opposite to the second direction D2 that biases the motor housing 28 in the first direction D1 relative to the torque strut 18. Because the motor bracket 16 (which is rigidly coupled to the motor 14 at a plurality of locations) is attached to the torque strut 18 at two locations—namely, the second and third bushings 40, 42—the motor bracket 16 (and hence, the motor 14) are restricted or prevented from rotating relative to the torque strut 18 and chassis 12 during either operating mode of the motor 14. That is, the second and third bushings 40, 42 react the moments generated during the propulsion mode and the regenerative-braking mode.

As described above, the torque strut 18 may be tuned to reduce vibration and noise generated during operation of the motor 14. That is, connection of the torque strut 18 to the motor bracket 16 at two locations (i.e., at the second and third bushings 40, 42) as well as the rigidity of the body 36 of the torque strut 18 may isolate the chassis 12 from relatively high-frequency vibration generated by the motor 14. This vibration isolation may reduce noise audible to people in the passenger compartment of the vehicle and reduce vibrations that can be felt during operation of the vehicle, thereby improving driver and passenger enjoyment and perception of quality.

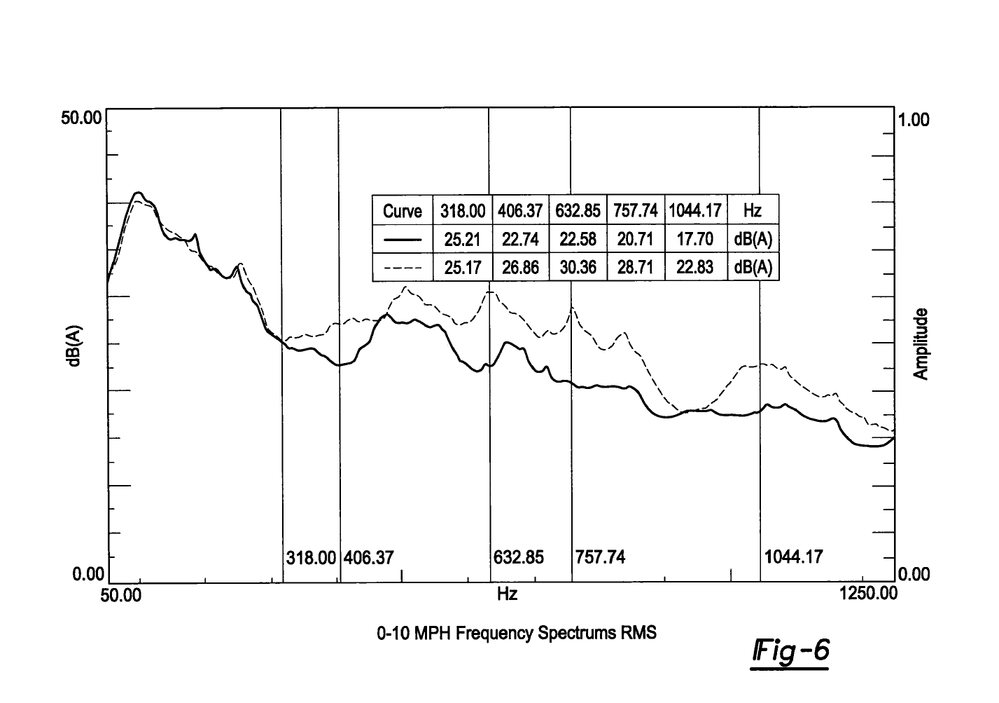

FIG. 6 illustrates the improvement in noise reduction due to implementation of the torque strut 18 of the present disclosure relative to a system having a prior-art torque strut. In the graph of FIG. 6, the solid line represents noise versus frequency or operating speed of the motor 14 for the system 10 of the present disclosure. The dashed line in the graph of FIG. 6 represents noise versus frequency or operating speed of the motor for a system having a prior-art torque strut. As shown in FIG. 6, implantation of the torque strut 18 of the present disclosure results in a reduction of noise over nearly the entire range of frequencies between 318 Hz and 1250 Hz.

1. A vehicle system comprising:
a vehicle chassis;
an electric motor including a rotor and operable in a first mode to rotate the rotor in a first direction about a rotational axis and in a second mode in which the rotor is rotated in a second direction about the rotational axis;
a motor bracket attached to the electric motor and including first and second attachment interfaces; and
a torque strut including a body and first, second and third bushings, the first, second and third bushings each including a mounting aperture having a longitudinal axis that is parallel to the rotational axis of the rotor, the first bushing disposed at a first end portion of the body and attached to the vehicle chassis, the second bushing disposed at a second end portion of the body and attached to the first attachment interface of the motor bracket, the third bushing disposed between the first and second bushings and attached to the second attachment interface of the motor bracket, the body portion extends in a straight linear direction between the first and second end portions such that a longitudinal axis of the torque strut extends through the first and second end portions, the longitudinal axis of the torque strut is perpendicular to the longitudinal axes of the mounting apertures.

2. The vehicle system of claim 1, wherein the body is a monolithic body.

3. The vehicle system of claim 1, wherein the torque strut is attached to the vehicle chassis only at the first bushing.

4. The vehicle system of claim 1, wherein a center-of-mass of the torque strut is disposed between the first and third bushings.

5. The vehicle system of claim 1, wherein the first bushing includes a larger diameter than the second and third bushings.

6. The vehicle system of claim 1, wherein rotation of the rotor in the second direction produces electrical energy.

7. The vehicle system of claim 1, the first bushing includes a plurality of openings arranged around the mounting aperture of the first bushing.

8. The vehicle system of claim 1, wherein the torque strut is tuned to reduce noise generated by the electric motor.

9. The vehicle system of claim 1, wherein the second and third bushings are configured to react a first moment generated by the electric motor when the electric motor is operating in the first mode and a second moment generated by the electric motor when the electric motor is operating in the second mode, and wherein the first and second moments are in opposite directions.

10. A system for a vehicle comprising:
a vehicle chassis;
an electric motor including a rotor and operable in a first mode to rotate the rotor in a first direction to propel the vehicle about a rotational axis and in a second mode in which the rotor is rotated in a second direction about the rotational axis; and
a torque strut including first, second and third mounting structures, the first mounting structure coupled to the vehicle chassis, the second and third mounting structures spaced apart from each other and coupled to the electric motor to prevent relative rotation between the torque strut and the electric motor, the torque strut extends in a straight linear direction between the first and second mounting structures such that a longitudinal axis of the torque strut extends through the first, second and third mounting structures.

11. The system of claim 10, wherein the second and third mounting structures are configured to react a first moment generated by the electric motor when the electric motor is operating in the first mode and a second moment generated by the electric motor when the electric motor is operating in the second mode, and wherein the first and second moments are in opposite directions.

12. The system of claim 11, wherein the torque strut is attached to the vehicle chassis only at the first mounting structure.

13. The system of claim 12, wherein the electric motor is mounted to a motor bracket, and wherein the torque strut is attached to the motor bracket only at the second and third mounting structures.

14. The system of claim 13, wherein the torque strut is tuned to reduce noise generated by the electric motor.

15. The system of claim 14, wherein the first, second and third mounting structures include first, second and third bushings, respectively.

16. The system of claim 15, wherein the first bushing includes a larger diameter than the second and third bushings.

17. The system of claim 15, wherein the first bushing includes a mounting aperture and a plurality of openings arranged around the mounting aperture.

18. The system of claim 10, wherein a center-of-mass of the torque strut is disposed between the first and third mounting structures.

19. (canceled)

20. The system of claim 10, wherein rotation of the rotor in the second direction produces electrical energy.
